(19) United States
(12) Patent Application Publication
(10) Pub. No.: US 2014/0173877 A1
(43) Pub. Date: Jun. 26, 2014

(54) HOLELESS PLATE MEMBER RIVETING METHOD

(71) Applicant: Ming-Chung CHIU, Keelung City (TW)

(72) Inventor: Ming-Chung CHIU, Keelung City (TW)

(21) Appl. No.: 13/724,834

(22) Filed: Dec. 21, 2012

(51) Int. Cl. B23P 11/00

(52) U.S. Cl. CPC B23P 11/00
USPC 29/432.1

(57) ABSTRACT

A holeless plate member riveting method for riveting a retaining member to a holeless plate member using a press by: placing the holeless plate member on a first die of the press and attaching a mounting structure of the retaining member to the holeless plate member opposite to the first die, and then attaching a cavity of a second die of the press to the retaining member, and then operating the press to stamp the second die against the retaining member and the first die, forcing a cutting edge of the mounting structure of the retaining member to cut into the holeless plate member to the extent where a toothed portion and annular locating groove of an engagement structure of the retaining member are kept in permanent engagement with a deformed part of the holeless plate member.

### BACKGROUND OF THE INVENTION

1. Field of the Invention

The present invention relates to plate member riveting technology and more particularly, to a holeless plate member riveting method, which is practical for riveting a retaining member to a holeless plate member without destructing plate member surface leveling, maintaining the sense of beauty of the outer appearance of the plate member, enhancing structural stability and saving much installation time and cost.

2. Description of the Related Art

When mounting a circuit board at a metal plate member in an electronic device (cell phone, notebook computer, tablet computer, etc.), copper columns and screws are commonly used. During application, threaded bottom tips of copper columns are fastened to respective mounting screw holes of the metal plate member, and then the circuit board is placed on the top edges of the copper columns, and then screws are respectively mounted in respective through holes of the circuit board and threaded into the respective screw holes of the copper columns. When assembled, the copper columns keep the metal plate member and the circuit board spaced apart by a predetermined distance, preventing direct contact between the metal plate member and electronic components of the circuit board.

However, for allowing installation of copper columns in the metal plate member, the metal plate member must be processed to provide mounting screw holes using drilling and thread tapping techniques. This processing process complicates the installation, increasing the cost. Some manufacturers employ a riveting technique to affix copper columns to a metal plate member instead of the conventional screw connection technique. However, prior to riveting copper columns to a metal plate member, the metal plate member must be processed to provide rivet hole for riveting. Further, following the market trend to create electronic devices having light, thin, short and small characteristics, components for electronic devices must be as small as possible, and the surface space of circuit boards must be fully utilized. When making mounting screw holes or rivet holes on a metal plate member, the control of tools and related tool components must be accurately performed, avoiding deformation of the metal plate member. Further, when riveting copper columns to rivet holes of a metal plate member, copper columns may be not accurately riveted to the metal plate member in position, affecting further circuit board installation. Further, making rivet holes on a metal plate member for the installation of copper columns require much processing time, increasing the installation cost.

### SUMMARY OF THE INVENTION

The present invention has been accomplished under the circumstances in view. It is therefore the main object of the present invention to provide a holeless plate member riveting method, which is practical for riveting a retaining member to a plate member without making a rivet hole on the plate member, maintaining the sense of beauty of the outer appearance of the plate member and saving much installation time and cost.

To achieve this and other objects of the present invention, a method for riveting a retaining member to a holeless plate member is performed with the application of a press comprising a first die and a second die. The method comprises the step of placing the holeless plate member on the first die of the press and attaching a mounting structure of the retaining member to the holeless plate member opposite to the first die, the step of attaching a cavity of the second die of the press to the retaining member, and the step of operating the press to stamp the second die against the retaining member and the first die, forcing a cutting edge of the mounting structure of the retaining member to cut into the holeless plate member to the extent where a toothed portion and annular locating groove of an engagement structure of the retaining member are kept in permanent engagement with a deformed part of the holeless plate member.

During the riveting process, the cavity of the second die of the press is attached to the cylindrical body of the retaining member to stop the inner bottom wall of the cavity of the second die at the top wall of the cylindrical body of the retaining member. Therefore, the second die and the retaining member are stably held on the holeless plate member for riveting, avoiding displacement. Thus, continuously stamping the second die against the top wall of the cylindrical body of the retaining member can accurately and positively force the toothed portion and annular locating groove of the engagement structure into permanent engagement with the holeless plate member.

After the retaining member and the holeless plate member have been riveted together, a second plate member (for example, circuit board) can be attached to the top wall of the cylindrical body of the retaining member, and then a screw can be driven through the second plate member and threaded into the screw hole in the cylindrical body to affix the second plate member to the retaining member. At this time, the retaining member works as a spacer to keep the holeless plate member and the second plate member spaced apart by a predetermined distance. Further, the outer diameter of the cylindrical body of the retaining member can be within the range of 2 mm˜3.5 mm, or preferably, 2.5 mm. Thus, the installation of the retaining member in the holeless plate member does not affect the circuit layout of the holeless plate member (in the case of a circuit board).

### BRIEF DESCRIPTION OF THE DRAWINGS

FIG. 1 is a flow chart illustrating the performance of a holeless plate member riveting method in accordance with the present invention.

FIG. 2 is an exploded view of a retaining member and a holeless plate member before the performance of the holeless plate member riveting method in accordance with the present invention.

FIG. 3 is a schematic partial sectional view of the present invention, illustrating the holeless plate member attached to the first die of a press before riveting.

FIG. 4 is a schematic sectional view of the present invention, illustrating the retaining member attached to the holeless plate member at the top side of the first die of the press before attachment of the second die.

FIG. 5 is a schematic sectional view of the present invention, illustrating the second die stamped against the retaining member and the holeless plate member at the first die and the retaining member riveted to the holeless plate member.

### DETAILED DESCRIPTION OF THE PREFERRED EMBODIMENT

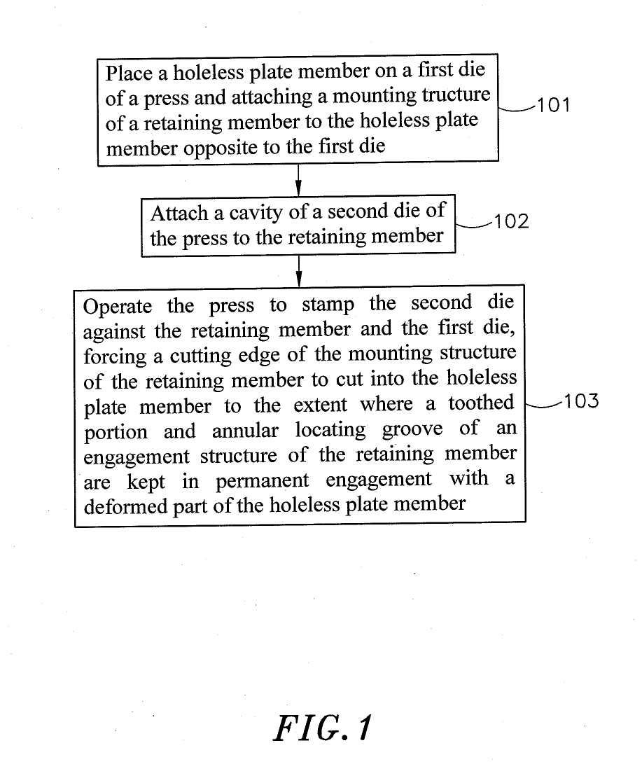

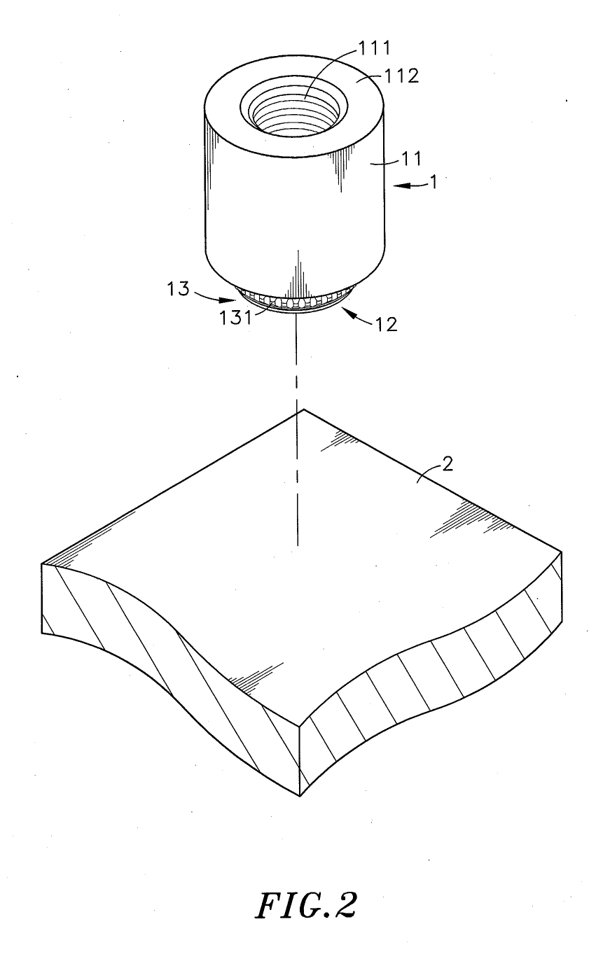

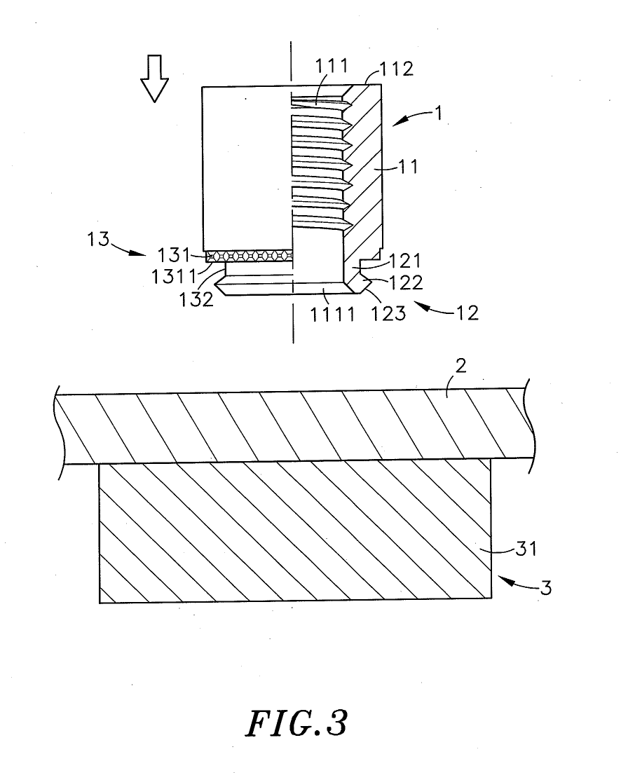

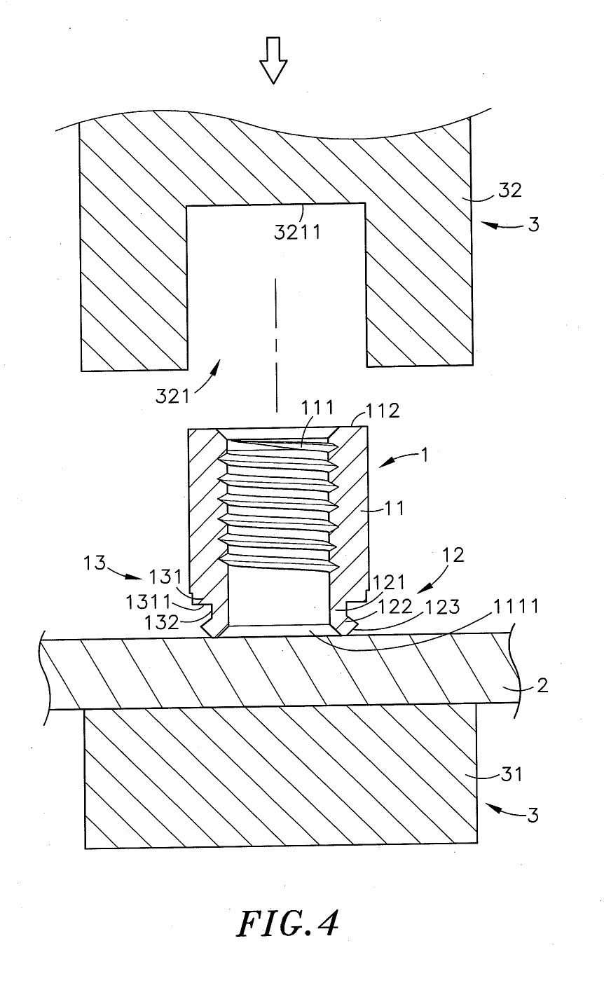

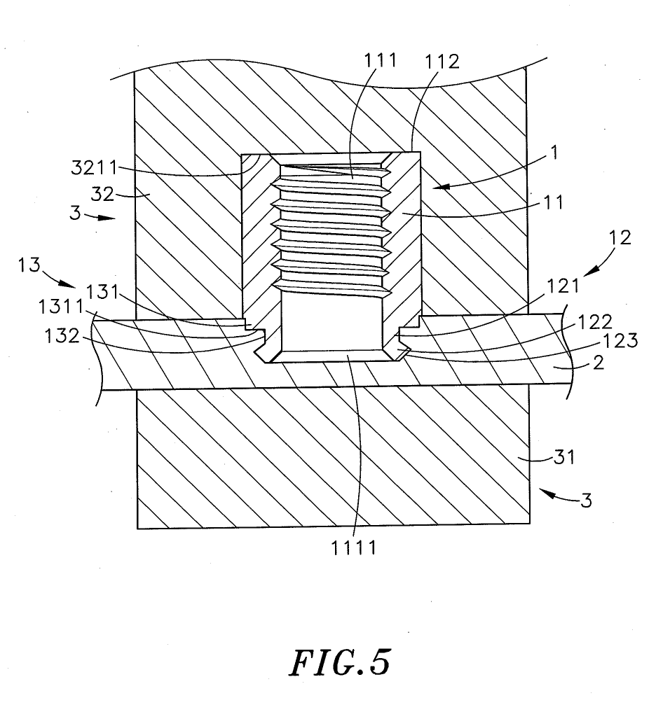

Referring to FIGS. 1-5, a holeless plate member riveting method in accordance with the present invention is shown for riveting a retaining member 1 to a holeless plate member 2.

The retaining member 1 is a one piece metal member comprising a cylindrical body 11 having a top wall 112 and an opposing bottom wall (not shown), a screw hole 111 extending through the top wall 112 and bottom wall of the cylindrical body 11, a sloping guide edge 1111 upwardly outwardly extended from a bottom side of the screw hole 111, and a mounting structure 12 and an engagement structure 13 located at a bottom side of the cylindrical body 11. The mounting structure 12 comprises a neck 121, a cutting edge 122 extending around a lower part of the neck 121, and a tangent edge 123 connected between the cutting edge 122 and the sloping guide edge 1111. The engagement structure 13 comprises a toothed portion 131 extending around the outer perimeter of the cylindrical body 11 above the neck 121 of the mounting structure 12, a bearing face 1311 horizontally connected between a bottom side of the toothed portion 131 and a top side of the neck 121, and an annular locating groove 132 defined around the neck 121. Further, the outer diameter of the toothed portion 131 of the engagement structure 13 is larger than the outer diameter of the cutting edge 122 of the mounting structure 12.

Further, the holeless plate member 2 can be a component of a cell phone, notebook computer, tablet computer, ultrabook or any other electronic device, or a plate member of a device housing or rack of an electronic device or equipment.

The holeless plate member riveting method comprises the steps of:
(101) Place the holeless plate member 2 on a first die 31 of a press 3, and then attach the mounting structure 12 of the retaining member 1 to one side of the holeless plate member 2 opposite to the first die 31 of a press 3.
(102) Attach a cavity 321 of a second die 32 of the press 3 to the cylindrical body 11 of the retaining member 1 to stop an inner bottom wall 3211 of the cavity 321 of the second die 32 at the top wall 112 of the cylindrical body 11 of the retaining member 1.
(103) Operate the press to stamp the second die 32 against the top wall 112 of the cylindrical body 11 of the retaining member 1, forcing the cutting edge 122 of the mounting structure 12 to cut into the holeless plate member 2 to the extent where the toothed portion 131 and annular locating groove 132 of the engagement structure 13 are kept in permanent engagement with deformed part of the holeless plate member 2.

As stated above, when riveting the retaining member 1 to the holeless plate member 2, place the holeless plate member 2 on the top side of the first die 31 of the press 3, and then attach the retaining member 1 to the top side of the holeless plate member 2 opposite to the first die 31 of the press 3 to keep the mounting structure 12 of the retaining member 1 in direct contact with the holeless plate member 2, and then attach the cavity 321 of the second die 32 of the press 3 to the cylindrical body 11 of the retaining member 1 to stop the inner bottom wall 3211 of the cavity 321 of the second die 32 at the top wall 112 of the cylindrical body 11 of the retaining member 1, and then operate the press 3 to stamp the second die 32 against the top wall 112 of the cylindrical body 11 of the retaining member 1. When stamping the second die 32 against the top wall 112 of the cylindrical body 11 of the retaining member 1, the first die 31 of the press 3 supports the holeless plate member 2 and the retaining member 1 against the pressure from the second die 32 of the press 3. When continuously stamping the second die 32 against the top wall 112 of the cylindrical body 11 of the retaining member 1, the cutting edge 122 of the mounting structure 12 will be forced to cut into the holeless plate member 2, deforming a part of the holeless plate member 2 and a part of the retaining member 1 and forcing the toothed portion 131 and annular locating groove 132 of the engagement structure 13 into permanent engagement with the deformed part of the holeless plate member 2. Subject to the engagement between the toothed portion 131 and annular locating groove 132 of the engagement structure 13 and the deformed part of the holeless plate member 2, the retaining member 1 is prohibited from rotation, displacement or vibration relative to the holeless plate member 2.

Further, the retaining member 1 can be made of aluminum, copper, stainless steel, zinc alloy, or any of a variety of other metallic materials and their alloys. Further, the outer diameter of the cylindrical body 11 of the retaining member 1 can be within the range of 2 mm˜3.5 mm, or preferably, 2.5 mm. Thus, the installation of the retaining member 1 in the holeless plate member 2 does not affect the circuit layout of the holeless plate member 2 (in the case of a circuit board). The holeless plate member 2 can be a thin metal sheet member relatively softer than the retaining member 1. As the stamping technique of operating the press 3 to drive the retaining member 1 into the holeless plate member 2 is of the known art, no further detailed description in this regard is necessary.

Further, after the retaining member 1 and the holeless plate member 2 have been riveted together, a second plate member (circuit board or shell) can be attached to the top wall 112 of the cylindrical body 11 of the retaining member 1, and then a screw (not shown) can be driven through the second plate member and threaded into the screw hole 111 in the cylindrical body 11 to affix the second plate member to the retaining member 1. At this time, the retaining member 1 works as a spacer to keep the holeless plate member 2 and the second plate member spaced apart by a predetermined distance.

The application of the present invention to rivet a retaining member and a plate member together eliminates the procedure of making a rivet hole on the plate member, saving much installation time and cost. Further, during the riveting process, the cavity 321 of the second die 32 of the press 3 is attached to the cylindrical body 11 of the retaining member 1 to stop the inner bottom wall 3211 of the cavity 321 of the second die 32 at the top wall 112 of the cylindrical body 11 of the retaining member 1. Therefore, the second die 32 and the retaining member 1 are stably held on the holeless plate member 2 for riveting, avoiding displacement. Thus, continuously stamping the second die 32 against the top wall 112 of the cylindrical body 11 of the retaining member 1 can accurately and positively force the toothed portion 131 and annular locating groove 132 of the engagement structure 13 into permanent engagement with the holeless plate member 2.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A holeless plate member riveting method for riveting a retaining member to a holeless plate member using a press comprising a first die and a second die, said retaining member comprising a cylindrical body having a top wall and an opposing bottom wall, a screw hole extending through the top wall and bottom wall of said cylindrical body, a sloping guide edge upwardly outwardly extended from a bottom side of said screw hole and a mounting structure and an engagement structure located at a bottom side of said cylindrical body, said mounting structure comprising a neck and a cutting edge extending around a lower part of said neck said engagement structure comprising a toothed portion extending around an outer perimeter of said cylindrical body above said neck of said mounting structure, and an annular locating groove defined around said neck, the outer diameter of said toothed portion of said engagement structure being larger than the outer diameter of said cutting edge of said mounting structure, the holeless plate member riveting method comprising the steps of:
(a) placing said holeless plate member on said first die of said press, and then attaching said mounting structure of said retaining member to one side of said holeless plate member opposite to said first die of said press;
(b) attaching a cavity of said second die of said press to said cylindrical body of said retaining member to stop an inner bottom wall of said cavity of said second die at the top wall of said cylindrical body of said retaining member; and
(c) operating said press to stamp said second die against the top wall of said cylindrical body of said retaining member, forcing said cutting edge of said mounting structure to cut into said holeless plate member to the extent where said toothed portion and annular locating groove of said engagement structure are kept in permanent engagement with a deformed part of said holeless plate member.

2. The holeless plate member riveting method as claimed in claim 1, wherein said mounting structure of said retaining member further comprises a tangent edge connected between said cutting edge and said sloping guide edge.

3. The holeless plate member riveting method as claimed in claim 1, wherein said engagement structure of said retaining member further comprises a bearing face horizontally connected between a bottom side of said toothed portion and a top side of said neck of said mounting structure.
